(19) United States
(12) Patent Application Publication
(10) Pub. No.: US 2006/0032594 A1
(43) Pub. Date: Feb. 16, 2006

(54) Window security closure assembly

(76) Inventor: Robert H. Morgan, Chapel Hill, NC (US)

Correspondence Address: Michael G. Gabriel;St. Onge Steward Johnston & Reens LLC, 986 Bedford Street, Stamford, CT, 06905-5619, US

(21) Appl. No.: 10/916,079

(22) Filed: Aug. 11, 2004

(51) Int. Cl. E06B 9/24

(52) U.S. Cl. 160/371

(57) ABSTRACT

A security closure assembly for an opening in a building comprises a surround and a security screen attached thereto. The surround includes a surface generally perpendicular to the window and a substantially outwardly facing surface which overlays the exterior of the building surrounding the window, and the generally perpendicular surface has a flange extending perpendicularly in a plane substantially parallel and exterior to the window. The security screen includes a screen frame attached interiorly to the surround flange in a way such that the surround flange overlays the screen frame and that the security screen is securely fastened to the surround without penetrating the surround.

### FIELD OF THE INVENTION

The present invention relates to a security closure assembly for a window, more particularly, a window security closure assembly having a security screen attached thereto for deterring vandalism and forced entry through the window in a building.

### BACKGROUND OF THE INVENTION

The Federal Department of Housing and Urban Development (HUD) and other governmental agencies require installation of security screens for various housing projects throughout the country. In addition, security screens are often required to be installed when a new school building is constructed or when an existing school building is renovated. The screens are typically installed over windows on the exterior of the first floor to protect the glass from vandalism and to prevent forced entry by intruders.

In order to ensure the effectiveness of the security screens, HUD, in conjunction with the Screen Manufacturer's Association, set minimum specifications (the “SMA Specifications”) for, among other things, the ability of security screens to withstand direct impacts, sustained loads and attempts at entry. These specifications and the related definitions have been published as the American National Standard Specifications for Metal Protection Screens (ANSI/SMA 6001-1 900) and are herein incorporated by reference.

The most rigorous of the SMA Specifications are for so-called “heavy” screens which are intended to prevent glass breakage and/or to deter forced entry through openings which are easily accessible. The “heavy” standards require in part that, during an impact by an 11 inch ball generating at least 100 lbf-ft (136 N-m) of force, a screen cloth must not stretch more than 3 inches. This distance is measured from the original plane of the screen cloth to the point of maximum displacement and applies to both temporary and permanent deformation. This procedure tests the strength and rigidity of both the screen cloth and the frame. The purpose of the limitation is to prevent breakage of the underlying glass due to objects thrown at the screens and to inhibit forced entry.

Typically, security screens are made with two frames. A first frame, often called the subframe, is fastened directly to the window opening, usually with bolts, screws, or other suitable connection means. This subframe anchors the screen and prevents it from being removed. Another frame, the main frame, holds the wire cloth and is attached to the subframe with hinges. There is also a lock that is used to secure the main frame to the subframe when closed.

The cost of installing the screens is high, especially in urban cities requiring prevailing wages. For example, large school window screens might cost $500 each, while the installation cost might be about $250 each in an urban city such as New York City.

One reason the screen installation is costly is that the screens are required to be installed in the masonry jambs surrounding the window. This means installation fasteners must be drilled into brick jambs, limestone sills and steel lintels. This is time consuming and difficult work. In addition, all screens must be field measured to ensure the proper fabrication size. Openings are not standardized and sizes will differ, increasing the number of different size screens that have to be made. Further complicating the process, the openings may not be square, necessitating special fitting pieces to fill in gaps.

Therefore, it is desired to provide a cost effective screen attachment method for securely connecting the screen to the window structure, such as a surround structure of a window, without penetrating the surround and thereby breaching the moisture barrier of the surround structure, without decreasing the amount of area through which light may pass, and without increasing the dimensions of the screen cloth or the main frame.

### SUMMARY OF THE INVENTION

Accordingly, the present invention is directed to a security closure assembly of a window, more particularly, a window security closure assembly having a security screen attached thereto for deterring vandalism and forced entry through the window.

According to one objective of the invention, instead of installing to the masonry opening as the conventional methods which typically requires costly installation works, the security screen of the invention is securely positioned onto the surround structure without breaching the moisture barrier of the surround structure which may cause invalidation of the window manufacturer's warranty. Utilizing the invention as described herein below, cost reduction of the security closure assembly may be significant when the security screen is attached to the surround due to, for instance, easier installation, reduced screen sizes, and elimination of field measuring of the screens.

These and other objects of the present invention are achieved by provision of a security closure assembly for a window opening in a building having a surround with an inner surround surface generally perpendicular to the window. At least one support member may extend perpendicularly from the inner surround surface in a plane substantially parallel and exterior to the window. A security screen having a screen frame positioned to overlay the support member. The support member is attached to the surround and that the screen frame is secured to the support member so that the inner surround surface is not penetrated.

The support member may be a flange integral with the surround or the support member may be a flange which is connected to the surround. The flange may be adhered to the surround with adhesive or double sided tape. The flange may have a protrusion extending substantially perpendicularly to the flange which may be connected to the surround with adhesive or double sided tape.

Preferably, the screen frame is secured with screws to the support member such that the inner surround surface is not penetrated. It is also preferred that the screen frame also be secured with adhesive or double sided tape.

The screen frame of the security screen includes a first frame attached to the support member, and a second frame operably connected to the first frame, and a screen member is attached to the second frame for covering the window opening. The first frame may have a generally U-shaped sectional configuration. The second frame may have a generally rectangular sectional configuration. The first frame may have a flexible contact attached to it and the flexible contact is disposed between the first frame and the second frame when the second frame is in a closed position. The screen member is attached to the second frame with a connection means and may include a guard plate for securely covering the attachment area of the screen member and the second frame.

The surround includes a sill member, a head member, a left jamb member, and a right jamb member. The first and second frames of either the left jamb member or the right jamb member may include a hinge operably connected between the first and second frames for selective opening and closing of the security screen.

The surround may also have a substantially outwardly facing surface which overlays the exterior of the building surrounding the window.

In certain embodiments, a second flange disposed adjacent to the first flange and extending generally parallel to the first flange from the inner surround surface, wherein the first and second flanges define a channel there-between. The screen frame is positioned within the channel defined by the first and second flanges and is secured within the channel with an adhesive or double sided tape and screwed into at least the first flange such that the inner surround is not penetrated.

These and other objects of the present invention are also achieved by provision of a security closure assembly for an opening in a building having a surround with an inner surround surface generally perpendicular to the exterior of the building. At least one support member extends perpendicularly from the inner surround surface and is secured to the surround by double sided tape or an adhesive. A security screen with a frame is positioned to overlay the at least one support member and is secured to the at least one support member with screws such that said inner surround surface is not penetrated. The screen frame may be further secured with double sided tape or an adhesive.

The objects of the present invention are further achieved by provision of a method of retro fit installation of a security closure assembly for a window opening in a building having the steps of providing an inwardly facing surface surrounding the window opening and securing a security screen having a screen frame to the window opening without drilling into the masonry around the window opening and without penetrating the inwardly facing surface surrounding the window opening.

The step of securing a security screen to the window opening preferably includes the steps of adhering a support member which extends perpendicularly from the inwardly facing surface and exterior to the window with double sided tape or an adhesive to the inwardly facing surface and positioning the security screen in the window opening such that the screen frame overlays the support member and a rear surface of the screen frame faces an exteriorly facing surface of the support member and securing the screen frame to the support member with screws.

Preferable, the method further provides for applying adhesive or double side tape between the rear surface of the screen frame and the exteriorly facing surface of the support member.

The step of providing an inwardly facing surface surrounding the window opening, also may have the step of installing a surround over the existing jamb in the window opening, the surround comprising an inwardly facing surface surrounding and a substantially outwardly facing surface which overlays the exterior of the building surrounding the window opening having a support member extending perpendicularly from the inwardly facing surface surrounding integral therewith.

The invention and its particular features, objectives, and advantages thereof will become more apparent from the following detailed description considered with reference to the accompanying drawings.

### BRIEF DESCRIPTION OF THE DRAWINGS

FIG. 1 is a cross-sectional view of the window security closure assembly according to the present invention.

FIG. 2 is a cross-sectional and partial view illustrating in more detail a part of the window security closure assembly of FIG. 1.

FIG. 3 is a cross-sectional and partial view illustrating in more detail an embodiment of part of the window security closure assembly of FIG. 1.

FIG. 4 is a cross-sectional and partial view illustrating in more detail another embodiment of part of the window security closure assembly of FIG. 1.

FIG. 5 is a cross-sectional and partial view illustrating a screen frame for use with the window security closure assembly of FIG. 1 which has a hinge shown in a closed position.

FIG. 6 is a cross-sectional and partial view illustrating a screen frame for use with the window security closure assembly of FIG. 1 with the hinge in an open position.

FIG. 7 is a cross-sectional and partial view illustrating an embodiment of the window security closure assembly.

### DETAILED DESCRIPTION OF THE DRAWINGS

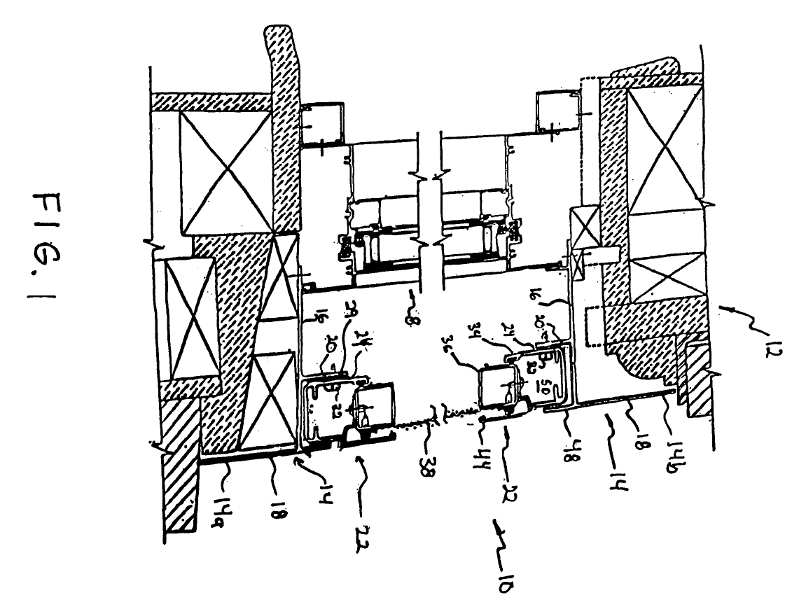

With reference to FIG. 1, a security closure assembly 10 for a window opening in a building 12 will have a surround 14 with an inner surround surface 16. The inner surround surface of the surround is generally perpendicular to the window 8. The inner surround surface may be on the existing jamb or panning of the window on which the security closure is installed. The inner surround surface may also be on a custom panning, installed for the purpose of providing a surface generally perpendicular to the window for the installation of the security closure assembly.

Extending perpendicularly from the inner surround surface 16 will be at least one support member 20. The support member 20 will extend in a plane substantially parallel to the window. The support member may be located at any position distally along the inner surround surface as long as it is exterior to the window. Thus the security assembly provides protection for the window. The screen frame 24 of the security screen assembly 22 is sized and positioned to overlay the support member 20 so that the screen frame 24 can be secured to the support member. As described below, the screen frame is secured to the support member such that the inner surround surface 16 is not penetrated and thus the moisture barrier of the surround is not compromised. Securing the security assembly in this manner also avoids the cost and labor of prior art security retro fit installations requiring installation into the masonry surrounding a window opening.

As illustrated in FIGS. 1 and 3, the support member 20 may be a flange 26 integral with the surround 14. While an integral flange extending from the surround may be found on the window opening's existing jamb or panning, it is also envisioned that a custom panning be installed over the existing window jamb which would provide a support member or flange for the purpose of the installation of the security closure assembly.

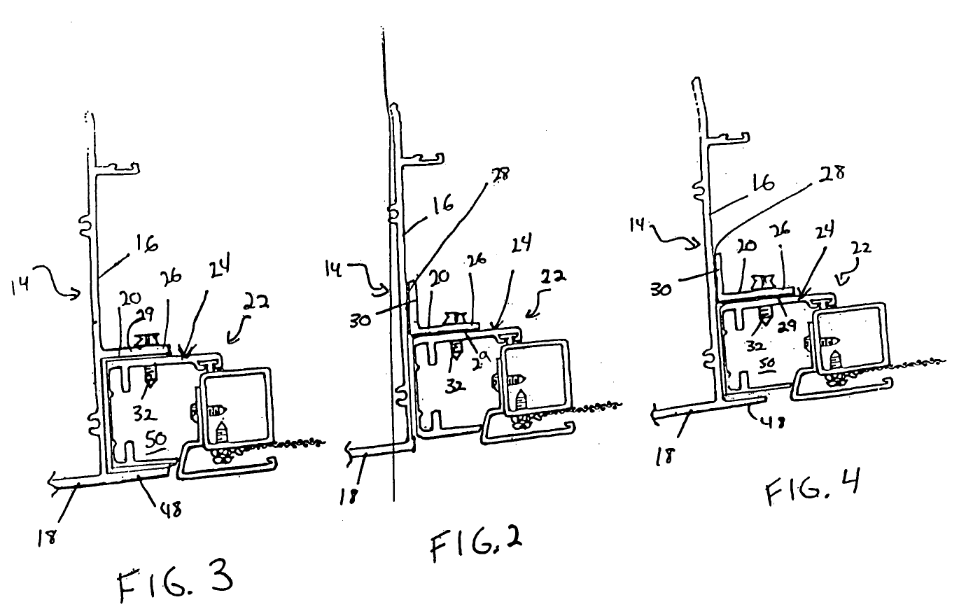

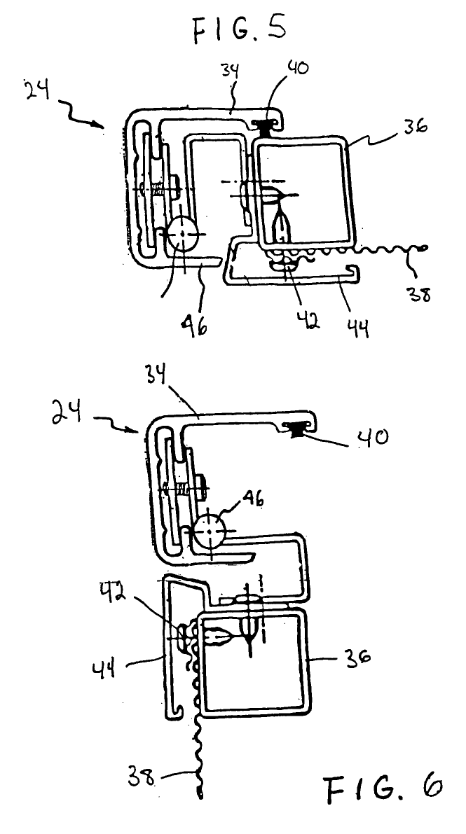

Alternatively, the support member may be a separate member or flange 26 which must be connected to the surround (FIGS. 2 and 4). It is envisioned that in the case where the existing window jamb of a window opening provides an inner surround surface generally perpendicular to the window, a separate support member may be used. The support member 20 may be adhered to the surround with double sided tape 28 or other known adhesive means. Such a separate support member may be made up of a flange 26 and a protrusion 30 extending substantially perpendicularly to the flange 26. The protrusion 30 may serve as the contact point for connection with the surround by a known adhesive. Preferably double sided tape 28 is used to connect the support member to the surround.

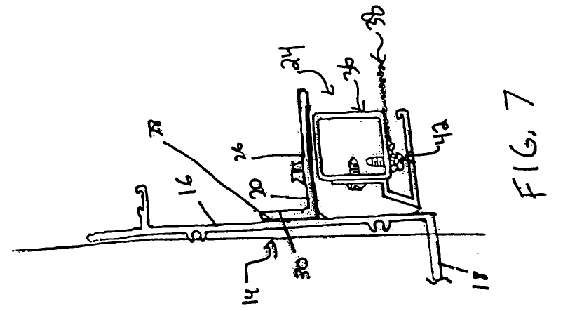

In certain embodiments, the screen frame of the security screen comprises a first frame and a second frame. Referring to FIGS. 5 and 6, the screen frame 24 of the security screen includes a first frame 34 which attaches to the support member, and a second frame 36 which is operably connected to the first frame 34. A screen member 38 is attached to the second frame 36 for covering the window opening. In an embodiment, the first frame 34 may have a generally U-shaped sectional configuration while the second frame 36 may have a generally rectangular sectional configuration. A flexible contact 40 may be attached to the first frame and be disposed between the first frame and the second frame when the second frame is in a closed position to seal any gap between the frames. The screen member 38 is attached to the second frame 36 with any known connection means such a screws 42.

However, the frame can be in the form of other suitable frame structures known in the art. For example, in certain other embodiments, such as those represented by FIG. 7, the screen frame 24 comprises a frame 36. A screen member 38 is attached to the frame 36 for covering the window opening with a screw 42, although in other embodiments other connection means are utilized. The frame 36 is attached to the support member 20.

FIGS. 5 and 6 illustrate a guard plate 44 for securely covering the attachment area of the screen member 38 and the second frame 36. The guard plate 44 may have a generally L-like shape with an extended free end covering the connection area of between the screen 38 and the second frame 36 for preventing unwanted alteration or vandalism by an intruder.

The first and second frames 34 and 36, the guard plate 44, and the screen 38 are formed of a suitable material and dimensioned to have a sufficient strength to withstand against vandalism and satisfy the requirements of HUD, the SMA Specifications, and of other governmental agencies governing commercial or public buildings.

Once the screen frame 24 is positioned within the window opening, the rear surface of the first frame 34 of the screen frame 24 is fastened or attached to the support member 20 or flange 26 by known connection methods, such as bolting, riveting, and welding, etc. Preferably, the screen frame 24 is secured with screws 32 to the support member 20 so that the inner surround surface 16 is not penetrated. The screws 32 may be inserted towards the window as shown in FIG. 1 or towards the building exterior as in FIGS. 2 through 4. It is also preferred that the screen frame also be secured to the screen frame 24 with an adhesive or double sided tape 29. An adhesive or double sided tape 27 may also be applied between the screen frame and the surround.

The surround 14 typically consists of a sill member 14a, a head member 14b, a left jamb member (not shown), and a right jamb member 14d for respectively covering the lower, upper, left, and right sides of the exterior of the window opening. The sill member 14a, head member 14b, left jamb member 14c, and a right jamb member 14d may have similar or different configurations and dimensions depending on the particular designs of the window opening of the building. Each of the surround members 14a, 14b, 14c and 14d can be formed of aluminum, metal alloy, or other suitable material, preferably formed into one piece by extrusion or other methods known in the art.

The first and second frames of either the left jamb member or the right jamb member may include a hinge operably connected between the first and second frames for selective opening and closing of the security screen. This feature allows evacuation of the occupants in emergency situations while preventing unwanted or forced entry by outside intruders. It is preferable to use the operable security screen feature described herein either to the left jamb member or the right jamb member because it allows opening and closing of the security screen in a horizontal direction.

FIG. 5 illustrates the screen frame 24 with the second frame 36 in a closed position, where the screen frame 24 securely protects the interior area of the window opening as shown in FIG. 1. It is preferable to provide a locking means (not shown) to lock and unlock from the inside of the security screen upon closing, and thus preventing forced entry of the outsider intruders while allowing selective entry by the occupants of the building.

FIG. 6 illustrates the screen frame 24 with the second frame 36 in an open position, where the second frame 36 is opened by operation of the hinge 46. This position allows passage of the building occupants through the security screen, for example, in an emergency situation.

The surround may also have a substantially outwardly facing surface 18 which overlays the exterior of the building surrounding the window. Suitable sealing means known in the art can be applied to the edges of the outward surface 18 to prevent water penetration between the surround and the building.

In certain embodiments (see FIGS. 3 and 4), a second flange 48 may be disposed adjacent to the first flange 26. The second flange 48 extends perpendicularly from the inner surround surface 16 and is generally parallel to the first flange 26. The first and second flanges define a channel 50. The screen frame 24 is positioned within the channel defined by the first and second flanges and is secured within the channel 50 with an adhesive or double sided tape 29 and screwed 32 into at least the first flange 26 such that the inner surround surface 16 is not penetrated.

The present invention provides a method of retro fit installation of a security closure assembly for a window opening in a building without drilling into the masonry around the window opening and without penetrating the inwardly facing surface surrounding the window opening.

If an inwardly facing surface surrounding the window opening is not available, a surround can be installed over the existing jamb in the window opening to provide an inwardly facing surface on the surround.

Next, a support member which extends perpendicularly from the inwardly facing surface and exterior to the window may be adhered with double sided tape by positioning the security screen in the window opening such that the screen frame overlays the support member and a rear surface of the screen frame faces an exteriorly facing surface of the support member. The screen frame 24 is then secured to the support member with screws 32.

Preferable, the screen frame 24 is further secured by the application of double side tape between the rear surface of the screen frame and the exteriorly facing surface of the support member.

While this invention has been particularly shown and described with reference to preferred embodiments thereof, it will be understood by those skilled in the art that various changes and modifications in form and details may be made thereto without departing from the spirit and scope of the invention as defined by the appended claims.

What is claimed is:

1. A security closure assembly for a window opening in a building comprising:
a surround said surround comprising an inner surround surface that is generally perpendicular to a window;
at least one support member extending perpendicularly from said inner surround surface in a plane substantially parallel and exterior to the window;
a security screen, said security screen comprising a screen frame positioned to overlay said at least one support member wherein said at least one support member is attached to said surround and said screen frame is secured to the at least one support member such that said inner surround surface is not penetrated.

2. The security closure assembly of claim 1, wherein said at least one support member is a flange integral with said surround.

3. The security closure assembly of claim 1, wherein said at least one support member comprises a flange which is connected to said surround.

4. The security closure assembly of claim 3, wherein said at least one support member comprises a flange which is connected to said surround with adhesive.

5. The security closure assembly of claim 4, wherein said flange is adhered to said surround with double sided tape.

6. The security closure assembly of claim 5, wherein said flange further comprises a protrusion extending substantially perpendicularly to said flange and wherein said protrusion is connected to said surround.

7. The security closure assembly of claim 6, wherein said protrusion is connected to said surround with adhesive.

8. The security closure assembly of claim 7, wherein said protrusion is adhered to said surround with double sided tape.

9. The security closure of claim 1, wherein said screen frame is secured with screws to said at least one support member such that said inner surround surface is not penetrated.

10. The security closure of claim 9, wherein said screen frame is further secured with double sided tape to said at least one support member such that said inner surround surface is not penetrated.

11. The security closure assembly of claim 1, wherein the screen frame of said security screen includes a first frame attached to said at least one support member, and a second frame operably connected to the first frame, and a screen member is attached to the second frame for covering the window opening.

12. The security closure assembly of claim 11, wherein the first frame has a generally U-shaped sectional configuration.

13. The security closure assembly of claim 12, wherein the second frame has a generally rectangular sectional configuration.

14. The security closure assembly of claim 13, wherein the first frame has a flexible contact attached thereto, the flexible contact disposed between the first frame and the second frame when the second frame is in a closed position.

15. The security closure assembly of claim 13, wherein the screen member is attached to the second frame with a connection means.

16. The security closure assembly of claim 15, further including a guard plate for securely covering the attachment area of the screen member and the second frame.

17. The security closure assembly of claim 1, wherein the screen frame of said security screen comprises a one-piece frame attached to said at least one support member, the one-piece frame attached to a screen member for covering the window opening.

18. The security closure assembly of claim 1, wherein the surround includes a sill member, a head member, a left jamb member, and a right jamb member.

19. The security closure assembly of claim 18, wherein the first and second frames of either the left jamb member or the right jamb member include a hinge operably connected between the first and second frames thereof for selective opening and closing of the security screen.

20. The security closure assembly of claim 1, wherein said surround further comprises a substantially outwardly facing surface which overlays the exterior of the building surrounding the window.

21. The security closure assembly of claim 3, further comprises a second flange disposed adjacent to the first flange and extending generally parallel to the first flange from the surface generally perpendicular to the window of the surround, wherein the first and second flanges define a channel there-between.

22. The security closure of claim 21, wherein said screen frame is positioned within the channel defined by the first and second flanges and is secured within the channel with double sided tape and screwed into at least the first flange such that said inner surround surface is not penetrated.

23. A security closure assembly for an opening in a building comprising:
a surround, said surround comprising an inner surround surface generally perpendicular to the exterior of the building;
at least one support member extending perpendicularly from said inner surround surface, wherein said at least one support member is secured to said surround by adhesive; and
a security screen, said security screen comprising a screen frame positioned to overlay said at least one support member, wherein said screen frame is secured to the at least one support member with screws to said at least one support member such that said inner surround surface is not penetrated.

24. The security closure of claim 23, wherein said at least one support member is adhered to said surround by double sided tape.

25. The security closure of claim 23, wherein said screen frame is further secured with double sided tape to said at least one support member such that said inner surround surface is not penetrated.

26. The security closure assembly of claim 23, wherein said surround further comprises a substantially outwardly facing surface which overlays the exterior of the building surrounding the opening.

27. A method of retro fit installation of a security closure assembly for a window opening in a building comprising:
providing an inwardly facing surface surrounding the window opening; and
securing a security screen having a screen frame to said window opening without drilling into the masonry around the window opening and without penetrating the inwardly facing surface surrounding the window opening.

28. The method of claim 27, wherein the step of securing a security screen to said window opening further comprises:
adhering at least one support member extending perpendicularly from said inwardly facing surface and exterior to the window to said inwardly facing surface;
positioning said security screen in the window opening such that said screen frame overlays said support member and a rear surface of said screen frame faces an exteriorly facing surface of said support member; and
securing said screen frame to said support member with screws.

29. The method of claim 28, wherein the step of adhering at least one support member extending perpendicularly from said inwardly facing surface and exterior to the window to said inwardly facing surface, further comprising applying double sided tape between said at least one support member and said to said inwardly facing surface.

30. The method of claim 28, further comprising adhering the rear surface of said screen frame and the exteriorly facing surface of said support member.

31. The method of claim 30, further comprising applying double side tape between the rear surface of said screen frame and the exteriorly facing surface of said support member.

32. The method of claim 27, wherein the step of providing an inwardly facing surface surrounding the window opening, further comprises installing a surround over the existing jamb in said window opening, said surround comprising an inwardly facing surface surrounding and a substantially outwardly facing surface which overlays the exterior of the building surrounding said window opening having at least one support member extending perpendicularly from said inwardly facing surface surrounding integral therewith.

33. A method of retro fit installation of a security closure assembly for a window opening in a building comprising:
providing an inwardly facing surface surrounding the window opening;
securing a security screen having a screen frame to said window opening without drilling into the masonry around the window opening and without penetrating the inwardly facing surface surrounding the window opening; and
adhering at least one support member extending perpendicularly from said inwardly facing surface and exterior to the window to said inwardly facing surface.

34. The method of claim 33, wherein the step of adhering at least one support member extending perpendicularly from said inwardly facing surface and exterior to the window to said inwardly facing surface, further comprising applying double sided tape between said at least one support member and said to said inwardly facing surface.
